(19) United States
(12) Patent Application Publication
(10) Pub. No.: US 2015/0339773 A1
(43) Pub. Date: Nov. 26, 2015

(54) METHODS FOR MARKET RESERVATION

(71) Applicant: SPENCER SCHOCK, BEND, OR (US)

(72) Inventor: SPENCER SCHOCK, BEND, OR (US)

(21) Appl. No.: 14/714,669

(22) Filed: May 18, 2015

Related U.S. Application Data
(60) Provisional application No. 62/002,077, filed on May 22, 2014.

(51) Int. Cl. G06Q 40/04

(52) U.S. Cl. CPC G06Q 40/04

(57) ABSTRACT

Methods for market reservation include proposing a solution to a societal or other issue; reservation shares for this solution are created; these reservation shares are placed in an actively traded marketplace defined by bid price, time-in-market, and “benching” among other variables; investors reserve shares in the proposed solution; the proposed solution is refined by input from various sources; and the investors capitalize in the event that the solution is selected for implementation to resolve the issue.

### CROSS-REFERENCE TO RELATED APPLICATIONS

This application claims the benefit of U.S. provisional application No. 62/002,077, filed May 22, 2014 and entitled METHOD FOR MARKET RESERVATION, which provisional application is incorporated by reference herein in its entirety.

### FIELD OF THE INVENTION

Illustrative embodiments of the disclosure generally relate to methods of resolving complex issues such as societal issues related to public commons such as wetlands, forestlands and fisheries, for example and without limitation. More particularly, illustrative embodiments of the disclosure relate to methods for reservation markets in which a rudimentary solution to a societal or other issue is proposed; reservation shares for this solution are created; these reservation shares are placed in an actively traded marketplace defined by bid price, time-in-market, and “benching” among other variables; investors reserve shares in the proposed solution; the proposed solution is refined by input from various sources; and the investors capitalize in the event that the solution is selected for implementation to resolve the issue.

### BACKGROUND OF THE INVENTION

A “commons” is known as a natural or cultural resource typically accessible to all members of society. Examples of natural commons include fisheries, national parks, forests, and clean air. Cultural examples of commons include the rule of law, democracy, human rights, public education, and heritage sites.

Every commons is at risk of degradation. For example, fisheries can be over fished or a city watershed polluted or a democracy corrupted or a heritage site vandalized. In sum, the actions of a few have the potential to degrade an asset shared by many. Such degradation is not new to mankind; it has been a topic of philosophical discussions since Greek antiquity (Thucydides 460-395 BC and Aristotle 384-322 BC).

Degraded commons may be described in moral, cultural or biological terms or in any number of other ways. One way to define degraded commons is in economic terms. One economic model which may be used to describe degradation of commons is known as “Tragedy of the Commons”, which was detailed in a 1968 report written by biologist Garrett Hardin. Hardin's report describes situations in which an individual reaps all the gain from a given activity while society bears the cost of that activity. One example Hardin used was cattle herdsmen grazing cattle on a meadow. Modern examples include the following: (1) a fisherman catches an endangered loggerhead sea turtle, he reaps all of the catch while the world bears the cost of that turtle loss; 2) when a gasoline automobile is driven, the driver reaps all of the benefit of that activity while society bears the cost of increased air pollution; and 3) when a politician chooses to deficit spend, he or she reaps all of the political clout associated with that spending while future generations bear the cost of repayment. In each of these cases, gain is concentrated in the hands of one while the cost of that activity is dispersed across many. This is a “tragedy” because each activity, while rational in economic terms for the individual, is destructive and thus irrational for society as a whole.

Society may arrest the destructive force of degraded commons through two forms of intervention: 1) Government taxation, in which government may, for example, impose taxes on auto fuel in an effort to reduce fuel consumption and corresponding air pollution; and 2) Government regulation, in which government may, for example, set limits and police the fish catch along its coastline in an effort to maintain healthy fish stocks. Both forms of intervention have enjoyed success in reducing destructive practices, particularly in advanced nations where laws are enforced. The problem with tax and regulatory efforts, however, is that as authorities clamp down the corresponding economic reward for evading this government constraint grows. The consequence is a diminishing marginal return on efforts to limit destructive practices. In short, more intense policing means more profitable poaching (or similar degradation via tax evasion, political pressure, lobbying, corruption, etc.). The power of this “push back” is perhaps most clearly revealed in our natural commons. Despite decades of well-intentioned tax and regulatory efforts, stocks of fish, wildlife and biodiversity continue to diminish at an alarming rate around the world. A recent study by the World Wildlife Fund, the Zoological Society of London, and others determined that world wildlife populations plunged 52% between 1970 and 2010.

Tragedy of the Commons is an example of a heretofore insoluble problem—one that has not been resolved through education, government policy, technological advancement, or the general advance of mankind. An estimated 2,000 technical papers and books have been written worldwide in an attempt to solve Tragedy of the Commons (also called Prisoner's Dilemma) In 2009, Elinor Ostrom won the Nobel Prize in Economics for her work on this issue. Nonetheless, a key to resolving issues related to the degradation of commons remains elusive. None, including Ostrom, have unlocked the puzzle.

Tragedy of the Commons, however, may be solved through the application of reservation markets.

Advanced economies throughout the world fund innovation and attempt to solve problems primarily through the application of the following tools: 1) The trading of securities on stock and futures exchanges; 2) The sale and purchase of corporate or institutional debt; and 3) The pledging of funds through direct investment, government expenditures, or venture capital agreements. In each case, agreements are transacted in real currency and each transaction represents a contractual obligation on the part of participants. These funding tools, in various forms of evolution, have existed for thousands of years.

Reservation markets represent a departure from conventional approaches for funding innovation and resolving problems. Reservation markets are more elastic and less contractual in comparison to conventional funding tools. This plasticity allows reservation markets to confront complex challenges (such as those defined by Tragedy of the Commons) and test hundreds of potential solutions prior to the funding of solutions. In this manner, reservation markets represent both a design and funding tool for resolving complex issues.

### SUMMARY OF THE INVENTION

Illustrative embodiments of the disclosure are generally directed to methods for reservation markets, including: submitting an issue to be resolved; proposing at least one rudimentary solution to the issue to be resolved; measuring suitability and interest of potential investors in the at least one rudimentary solution to the issue to be resolved; establishing a reservation market having reservation shares for each of the at least one rudimentary solution; receiving a bid or offer from at least one investor from among the potential investors for at least one reservation share in the reservation market; formulating a finished solution; and providing the at least one investor with an option of retaining the at least one reservation share in the reservation market at a price corresponding to the bid or offer. An illustrative embodiment of the methods includes: receiving an issue to be resolved from at least one subscriber; proposing at least one rudimentary solution to the issue to be resolved; measuring suitability and interest of potential investors in the at least one rudimentary solution to the issue to be resolved; establishing a reservation market having reservation shares; receiving a bid or offer from at least one investor from among the potential investors for at least one reservation share in the reservation market; receiving input and proposed refinements of the at least one rudimentary solution from at least one of the at least one subscriber, the general public, an implementing entity and/or at least one of the at least one investor; formulating a finished solution based on the input and proposed refinements of the at least one rudimentary solution by revising and refining the at least one rudimentary solution; sanctioning the finished solution; providing the at least one investor with an option of retaining the at least one reservation share in the reservation market at a price corresponding to the bid or offer; and implementing the finished solution.

### BRIEF DESCRIPTION OF THE DRAWINGS

Illustrative embodiments of the disclosure will now be described, by way of example, with reference to the accompanying drawings, in which:

FIG. 1 is a functional block diagram which illustrates a typical system in implementation of an illustrative embodiment of the methods for market reservation;

FIG. 2 is a flow diagram which illustrates an illustrative embodiment of the methods for market reservation; and

FIG. 3 is a block diagram which illustrates an illustrative reservation market according to the methods for market reservation.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable users skilled in the art to practice the methods of the disclosure and are not intended to limit the scope of the claims. Moreover, the illustrative embodiments described herein are not exhaustive and embodiments or implementations other than those which are described herein and which fall within the scope of the appended claims are possible. Furthermore, there is no intention to be bound by any expressed or implied theory presented in the preceding technical field, background, brief summary or the following detailed description. The disclosure may make use of both the verb phrase “market reservation” and noun phrase “reservation market” throughout the disclosure.

Illustrative embodiments of the disclosure relate to methods for market reservation in which a rudimentary solution to an issue is proposed; reservation shares for this solution are created, these reservations are made available to investors through an active marketplace defined by bid price, time-in-market, and “benching” among other variables; investors reserve shares in the proposed solution; the proposed solution is refined by input from various sources; and the investors capitalize in the event that the proposed solution is selected for implementation. The proposed solution may include solutions to complex issues related to public commons such as wetlands, forestlands and fisheries, for example and without limitation. In some embodiments, the methods may be used to protect degraded commons through the creation of a reservation market. Reservation markets allow society to test new ideas for repairing degraded commons by allowing potential stakeholders (individuals, non-profit institutions, government agencies, corporations, etc.) to reserve shares in a solution proposed by the reservation market. Those proposed solutions which are backed by the most stakeholder and/or investor interest enjoy the greatest opportunity or likelihood for success. If a proposed solution comes to fruition, reservation holders may participate in that solution in accordance with their reservation of shares and the property or participatory or other rights provided by that reservation market.

Reservation markets may generate input from numerous entities, investors, regulatory agencies, stakeholders, the general public, the media, and others. In some embodiments, participants may be allowed to vote up or down on proposed refinements allowing the market provider to rank suggested refinements by various criteria. This input, combined with trading data, may reveal shortcomings in the proposed solution. These shortcomings may be resolved by refining and rebidding the proposed solution while reservation transactions are paused or while they continue to be actively traded. This process of refining and rebidding the proposed solution may be repeated many times over, potentially over a period of years, as a means of perfecting and fully vetting proposed solutions. Accordingly, the reservation markets which are created according to the methods of the disclosure may be used as a tool for introducing and refining new, incomplete, or rudimentary ideas before they are launched.

Reservation markets provide a more elastic and less contractual arrangement for managing innovation in comparison to conventional funding tools. Their plasticity allows reservation markets to confront complex challenges and test hundreds of potential solutions prior to the funding of solutions. In this manner, reservation markets represent both a design and funding tool for resolving complex issues.

Reservation markets may differ from conventional funding tools (such as but not limited to stock markets, bond markets, and government procurements) in the following ways:

1) Reservation shares in reservation markets may be non-binding. Investors may cancel their reservation, without penalty, at any time.
2) Reservation markets may not be contractual. Investors may agree to the general terms of a proposed solution and participate in the corresponding reservation market, but do so before having signed a contractual agreement related to the market.
3) Reservation markets may trade on the basis of an investor's reserve value. This reserve value is a reflection of an investor's net worth and is not an internationally accepted currency.
4) Reservation markets may utilize a formula, called engagement value, to determine winning bids. Engagement value may be a combination of an investor's bid price and that investor's accumulated investment time in a given reservation market.
5) Reservation markets may have a mechanism by which investors can displace or bench existing reservation holders by offering a better engagement value than the existing reservation holder. Investors in reservation markets can make reservations, cancel reservations, and bench other investors' reservations—but they cannot sell their reservations.
6) Reservation markets may close at an exact time and date that may be unknown to investors or to the general public prior to close.

These unique characteristics of reservation markets may create a fluid marketplace in which proposals may be altered while shares in the proposal are being actively traded, investment scenarios tested, likely outcomes revealed and potential investors discovered, all in a systematic manner unavailable to investors utilizing existing investment tools.

Reservation markets may allow investors to reserve shares in a proposed product, service or idea. If the proposal comes to fruition, these investors may be the first in line to invest in the finished proposal with real money at a later date. Like existing funding tools, reservation markets signal investor intent and corresponding value, but do so in a capital-free manner.

Capital-free investing provides both investors and society with unfathomable latitude to entertain, process, and invest in new products, services, and ideas. Reservation markets are bound only by one's imagination. Investors may be able to test every imaginable hypothesis, activity, formula, and/or investment scenario using reservation markets, and do so without experiencing financial loss.

In theory, because they do not use internationally recognized currency, reservation markets have the potential to double or triple or advance by some unknown factor societal investment in innovation without creating inflationary pressures.

Reservation markets, by design, may begin with a rudimentary or incomplete proposal and then use the trading of reservation shares as a tool (combined with input from investors, the media, the general public, and others) to refine and rebid the proposal. Here, trading in reservation markets is used not simply to arrange funding for a proposal but to design the proposal.

In the public arena, reservation markets provide investors with an opportunity to reform the design and function of government agencies, projects, and services. Reservation markets may test and refine solutions that have not yet been sanctioned by government authorities or the voters themselves. For example, reservation markets might be used to test various methods for managing a coastal fishery, including unorthodox and/or even unauthorized approaches. In this manner, reservation markets provide an opportunity to introduce and test various adaptations of current policy in search of possible alternatives and improvements. For example, changing the fishing season parameters may improve economic outcomes for fishermen, or replacing factory fishing with sport fishing may increase government revenue, or providing a method for fisherman to sell their fishing licenses/quotas to environmental groups who in turn let the licenses/quotas expire unused may improve environmental outcomes. Allowing fishermen, regulators, environmentalists, and other stakeholders to bid on these proposals, via reservation markets, can reveal these outcomes in advance of implementation and in a manner that heretofore has not been achievable with conventional funding tools and/or political forums.

Reservation markets allow bidding to take place in advance of regulatory change. This provides investors, regulators, and the general public with a clear view of what will happen if and when the regulatory change is adopted. Ideas may be vetted for sustainability, financial viability, legality, and more. This process provides regulators with an opportunity to design and implement change in a manner that improves levels of compliance, safety, efficiency, etc. for market participants and improves results for society overall.

In the public arena, reservation markets may represent a new form of free speech. Authorization of a given reservation market resides with government entities such as regulators, legislatures, or the voters themselves. In some cases, a reservation market may comply with existing law; in others, it may represent new law. In either case, reservation markets are entirely legal in the public arena as approval of and liability for a given proposal rests with governing authorities.

In sum, reservation markets represent a better blueprint for investors, regulators, and the general public. These markets represent a new way to introduce, publicize, measure, weigh, choose, queue up, design, and implement innovation.

Whereas an auction system delivers goods to the highest bidder, a reservation system delivers goods to the earliest bidder. Reservation markets represent a new hybrid construct of these two diametrically opposed systems. Investors in reservation markets secure reservation shares through the application of two variables: bid price and accrued investment time in the market. If an investor has accrued time in a given reservation market (already held shares in the market for a period of time), that investor may be able to secure and hold those reservations through the close of the market even though that investor may not have the highest bid. In essence, the market is looking for the most committed investor from the standpoint of amount invested and time in the market.

Reservation markets can be designed to more heavily weigh auction outcomes or more heavily weigh reservation outcomes simply by changing the time variable in the market calculations. Changing this variable can lead to dramatically different outcomes related to market funding and/or mix of investors.

Reservation markets are not static in design. Reservation market creators may take into account trading data and feedback from investors, the public, the media, or others and use that information to refine the market. In some embodiments, participants may be allowed to vote up or down on proposed refinements allowing the market provider to rank suggested refinements by various criteria. The reservation market creator may pause the market for refinements and then rebid the market or refine the market while reservations are actively traded. This process of refining and rebidding may be repeated many times, potentially over a period of years, as a means for improving and fully vetting proposed solutions. It is in this manner, by combining trading data with collaboration, that reservation markets become a tool for finding answers to complex societal issues.

In many instances, degraded commons are profitably mined or poached by a select few. These few enjoy intimate knowledge of their activity—the financial stakes involved and all related stakeholders. These select few are able to use this information and funds from their mining or poaching to mount a well-financed and well-organized effort to defend the status quo and resist change. We call this possession dominance. Those with possession dominance enjoy price knowledge, stakeholder knowledge, and revenue from their poaching (or other) activity. Challengers of this status quo typically do not enjoy the same advantages. The challenger cannot say with certainty what the price, stakeholder, or innovative outcomes of his or her proposed solution will be. The challenger can only offer a hypothetical solution. This uncertainty represents a significant liability for any challenger attempting to rally others to his or her cause, fund his or her challenge, and convince those in authority to overturn the status quo. The reservation markets formulated according to the methods of the disclosure may be designed to introduce and vet new ideas to overcome possession dominance. The methods may also provide challengers of the status quo with the price, stakeholder and innovative clarity they presently lack. This data can be used to alter the nature of the contest in a manner that provides the challenger of the status quo greater traction with regulatory authorities, potential investors, the general public, the media, and others than would otherwise be the case. The methods of the disclosure may also alter the nature of the challenger itself. In some instances, reservation markets may empower an old foe of the status quo. In other instances, the methods of the disclosure may reveal and empower an entirely new and unexpected challenger to the status quo.

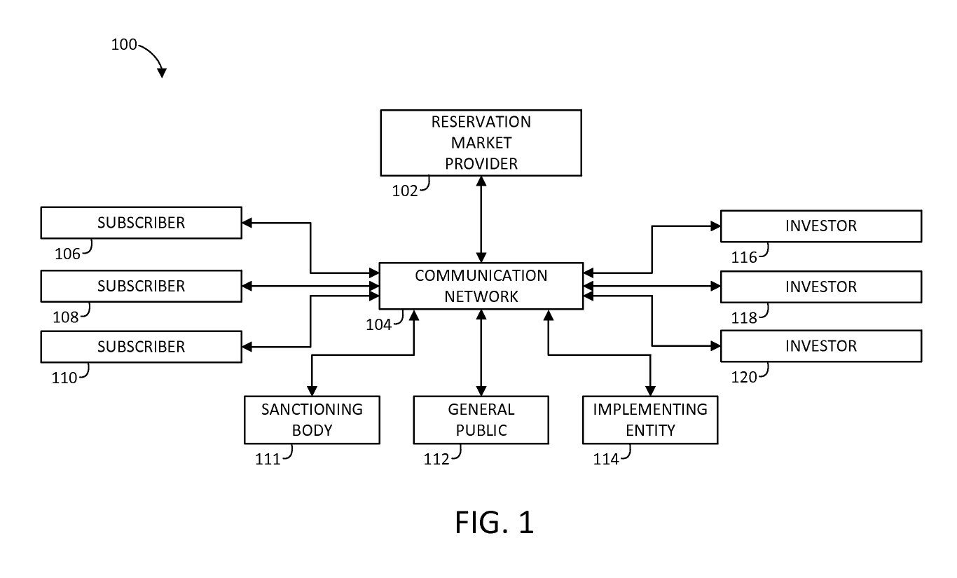

Referring to FIG. 1 of the drawings, a typical system 100 in implementation of an illustrative embodiment of the methods for market reservation is illustrated. The system 100 includes a reservation market provider 102 which manages the communication network 104. In some applications, the reservation market provider 102 may initiate a reservation market by proposing an issue which is to be resolved by the market. At least one subscriber 106, 108, 110 may communicate with the reservation market provider 102 through a communication network 104. In some applications, the at least one subscriber 106, 108, 110 may initiate a reservation market by proposing an issue which is to be resolved by the market and submitting the proposed issue to the reservation market provider 102. At least one investor or potential investor 116, 118, 120 may communicate with the reservation market provider 102 through the communication network 104. The general public 112, the sanctioning body 111, and the implementing entity 114 may additionally communicate with the reservation market provider 102 typically through the communication network 104.

In implementation of the methods for market reservation, which will be hereinafter further described, a reservation market provider 102, one or more subscribers 106, 108, 110, one or more potential subscribers 106, 108, 110, or any other entity defines an issue to be resolved by a reservation market. A reservation market is then created to address the need. The market may consist of a rudimentary proposed solution with property or participatory or other rights in that solution divided into reservation shares and made available to investors in a marketplace. Investors 116, 118, 120 compete for these shares by making non-binding reservations for the shares. The reservation market provider 102 may award reservations on the basis of engagement value (a value that may vary by market and represents a combination of amount bid and the investor's accrued investment time in the market). The formula for the engagement value of each investor 116, 118, 120 may be set at any point between the following end points: (time in market=0%/bid price=100%) and (time in market=100%/bid price=0%).

In some embodiments, investors with greater engagement values may displace or “bench” investors with lower engagement values when seeking possession of reservations. In this manner, reservations flow to those investors that demonstrate the greatest commitment to the market as defined by the market creator's engagement value formula.

An investor's ability to participate in a given reservation market may be determined by his or her assigned reserve value. Reserve value is a function of an investor's real-world net worth. Investors with greater net worth (i.e. a public university) are assigned a greater reserve value than are those with less net worth (i.e. a high school student). Investors may also be screened on the basis of risk tolerance, investment experience, credit worthiness, and other factors which indicate the investor's fitness for investing, and these factors may limit or enhance the investor's ability to participate in a given reservation market.

The reservation market provider 102 may revise and refine the rudimentary solution provided by the reservation market based on input from one or more of the subscribers 106, 108, 110, the general public 112, one or more of the investors 116, 118, 120, the sanctioning entity 111, the implementing entity 114, and/or any other entity. The reservation market provider 102 may present refined solutions to the subscribers 106, 108, 110, the general public 112, one or more of the investors 116, 118, 120, the sanctioning entity 111, the implementing entity 114, and/or any other entity at multiple times throughout the process until a finished solution is attained. Accordingly, analysis of trading data may allow for additional improvements or refinements to be implemented in the proposed solution. When refinements are made, the market may be paused and re-launched with the new revisions in place or it may be continuously traded during the time of revision by investors 116, 118, 120.

In some embodiments, the reservation market may reach a funding plateau, participation plateau, suitable level of public exposure, or any other criteria determined by the reservation market provider 102 as signaling an appropriate time to end or close the market. The reservation market provider 102 may then announce an impending closing time period. The exact time and date of closing within that period, however, in some embodiments may remain unknown in advance of the exact time of closing. For example, a market creator may announce that a market is scheduled to close in the month of June, but the exact day and time of closing (June 29, 2:30 PM EST) remains unknown to the general public 112, investors 116, 118, 120, and others. An unknown closing time incentivizes investors to reveal their intentions, bids, trading activity, interests, suggested refinements, and more sooner rather than waiting until the last moment. In doing so, market outcomes may be digested by the general public, stakeholders, regulators, and others in a more open and expedient manner than would otherwise be the case.

The now closed and finished solution may be submitted to a governmental or commercial entity or agency which may sanction the finished solution for implementation. The potential values, stakeholders and innovations for the finished solution may be revealed through the market prior to legal authorization or sanctioning of the finished solution. After the sanctioning body 111 legally sanctions the finished solution for implementation, the investors 116, 118, 120 may have the option of purchasing their reservation shares at their final winning bid price. Investors typically do not receive payment or dividend, but instead receive shares in the reservation market which bestow upon them property or participatory or other rights (license, authority, partnership, ownership, regulatory approval, etc.) as defined by the newly sanctioned market and corresponding agreements with governing entities. Investors' winning bids represent funding for the proposed solution and may be invested or distributed to various entities as defined by the parameters of the now sanctioned reservation market.

Accordingly, it will be appreciated by those skilled in the art that the reservation markets may provide the application of non-binding reservations which serve to accelerate transactions for a given product, service, good or commons, and in so doing, reveal financial values, stakeholders and potential innovations previously unknown to investors or the general public.

The reservation market provider 102 may include the personnel, capability and resources such as, but not limited to, website hardware and software which are necessary to implement the methods for market reservation. In some applications, the reservation market provider 102 may include computer hardware and software which are designed to facilitate or execute the method steps. In other applications, the reservation market provider 102 may have the capability and resources to implement the method steps without computer hardware, software or the Internet. It will be appreciated by those skilled in the art that reservation markets are not an evolutionary outcome related to the steady advance of technology, but are instead a standalone invention that could have occurred at any time in the history of mankind.

The communication network 104 may include one or more computer networks, the Internet, one or more telecommunications networks and/or any other electronic or non-electronic network or networks which facilitate communication between the reservation market provider 102 and the subscribers 106, 108, 110, the general public 112, the sanctioning body 111, the implementing entity 114 and the investors 116, 118 and 120. In some embodiments, the communication network 104 may include dedicated software which is used by the reservation market provider 102, the subscribers 106, 108, 110, the general public 112, the sanctioning body 111, the implementing entity 114 and the investors 116, 118, 120 for the purpose of participating in the reservation markets according to the methods of the disclosure. The software may include encryption and username/password access for security in transmission of information and data over the communication network 104.

A reservation market provider may create reservation markets itself and/or oversee other persons, agencies or entities that have been given authority by the reservation market provider to create their own reservation markets utilizing the reservation market provider's system. Those given authority to create such markets are called reservation market creators. The reservation market provider 102 may include one or more persons, agencies or entities that may create a reservation market and manage its functions, including but not limited to communication with investors, the general public, and others; presenting suggestions for refinements; choosing refinements for implementation; choosing to close the market during a certain time period; and on behalf of investors, stakeholders, and others negotiating the sanctioning of the market with governing authorities and/or the implementation of the market with implementing entities.

The subscribers 106, 108, 110 may include one or more persons, stakeholders, agencies or entities which are interested in resolving the issue or issues at hand in a particular reservation market and seek to be kept abreast of news and information related to the reservation market. The subscribers 106, 108, 110 may include, for example and without limitation, potential reservation holders or investors; commercial entities; natural preservation societies or entities; governmental agencies or regulators; members of the public; members of the media; and/or other persons, agencies or entities. In some applications, the subscribers 106, 108, 110 may include, for example and without limitation, persons, agencies or entities which would profit or benefit in a tangible manner from resolution of the issue at hand in the reservation market. In exchange for the services provided by the reservation market provider 102, the subscribers 106, 108, 110 may be required to obtain a subscription for a one-time subscription fee or recurring subscription fees.

In exchange for the services provided by the reservation market provider 102, the investors 116, 118, 120 may be required to obtain a subscription for a one-time subscription fee or recurring subscription fees, and/or pay a fee upon sanctioning of a market. The investors 116, 118, 120 may include persons, agencies or entities which are interested in bidding on reservations in a particular reservation market and seek to participate in the market should it be sanctioned by governing authorities.

The sanctioning body 111 may include a government agency, council, legislative body or other governing body which has authority to legally sanction the property rights or participatory rights or other rights proposed by the finished solution which is formulated in the reservation market. In some embodiments of the methods, the sanctioning body may be a private or commercial entity with the requisite authority to sanction property or participatory or other rights related to an asset or activity that the private or commercial entity owns or controls.

The implementing entity 114 may include a person, agency or entity which has familiarity with the problems and/or current approaches to the issue at hand and has the expertise, resources and/or legal authority to implement the solution which is formulated in the reservation market.

The stakeholders may include any of the above entities and may also include entities with no knowledge of or participation with the reservation market but who may be impacted in some manner by the reservation market and/or its sanctioning by the sanctioning body 111.

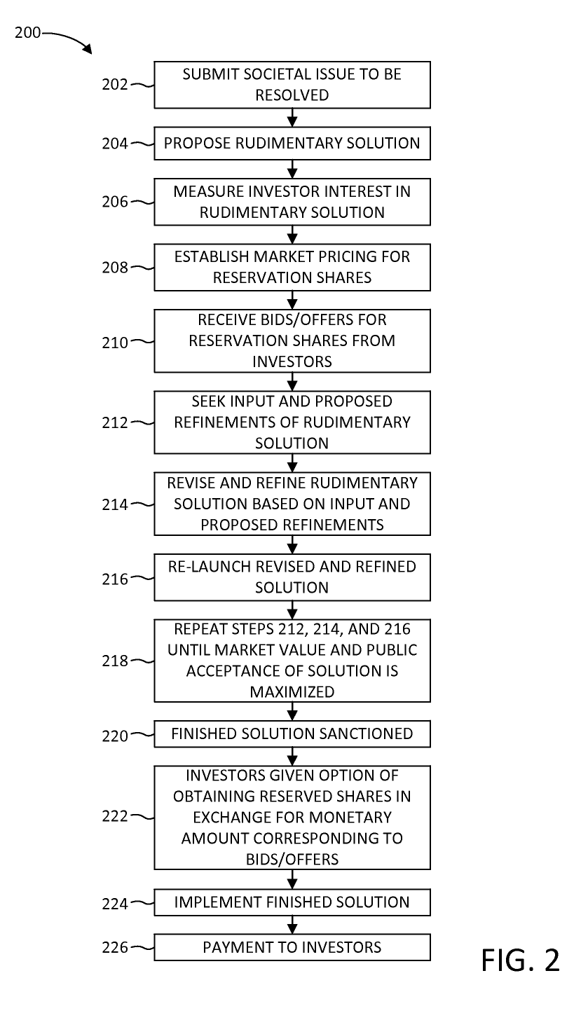

Referring to FIG. 2 of the drawings, a flow diagram 200 which illustrates an illustrative embodiment of the methods for market reservation is illustrated. The method 200 may be used as a tool for resolving complex issues related to public commons such as wetlands, forestlands and fisheries, for example and without limitation.

At Step 202, an issue which is to be resolved may be proposed by a reservation market provider or submitted to a reservation market provider by a subscriber, potential subscriber, market creator or any other entity.

At Step 204, a reservation market may be created by proposing one or more rudimentary solutions to the issue. The rudimentary solutions may be proposed by a subscriber, a potential investor, a commercial entity, a natural preservation entity, a governmental agency, a government regulator, a member of the public, a market creator, or other person, agency or entity. In some applications, the rudimentary solutions may be proposed by a person, agency or entity which has familiarity with the problems and/or current approaches to the issue at hand and has the expertise and resources to implement the solution. In some applications, the rudimentary solutions may be proposed by a person, agency or entity which has familiarity with the problems and/or current approaches to the issue at hand, but allows others with greater expertise and/or resources than the proposing entity to implement the solution.

At Step 206, investor suitability and interest in the proposed rudimentary solutions may be measured. The step may include evaluation of the investors' tolerance for risk, income, net worth, credit worthiness, investment experience, and other factors which indicate the investors' fitness for investing in the reservation market.

At Step 208, an opening share price for the reservation market may be established.

At Step 210, bids for non-binding shares in the reservation market may be received from interested investors. In some embodiments, the bid or bids of the investor or investors may be selected on the basis of the investor which has the highest engagement value. The formula for the engagement value of each investor 116, 118, 120 may be set at any point between the following end points: (time in market=0%/bid price=100%) and (time in market=100%/bid price=0%). Winning reservations may be displaced or benched by new or existing investors bidding with higher engagement values.

At Step 212, input and proposed refinements of the rudimentary solutions may be sought from the general public, a commercial entity, a governmental agency or government regulator or other person, agency or entity. This step may include reviewing market activity, reservation share pricing, investors' time in market, investors' participation in suggested refinements, transaction count, and more.

At Step 214, the proposed solutions may be revised and refined based on the input and proposed refinements which were solicited at Step 212.

At Step 216, the revised and refined solutions may be incorporated in the reservation market

At Step 218, Steps 212, 214 and 216 may be repeated until the market value and public acceptance of a finished solution is maximized or forms a plateau in terms of funding, investor participation, public interest, or other criteria for measuring market viability. The finished solution may be a refinement of the proposed solution having the greatest reservation holder or investor interest. In some applications, the method may be repeated hundreds of times, over a period of years, for a single solution in the reservation market. The method may be used to research and measure potential outcomes from thousands of variables. The potential values, stakeholders or investors and innovations for this finished solution may be revealed prior to legal authorization or sanctioning of the finished solution and may differ substantially from the original proposed solution.

At Step 220, the reservation market may be closed and trading halted at an exact time which is unknown to participants in the market in advance of the closing. The finished solution defined in the reservation market may then be legally sanctioned by a governing body which honors the property or participatory or other rights proposed by the solution.

At Step 222, the investor or investors with the highest engagement value(s) on the chosen solution at Step 218 may be given the option of obtaining their reserved shares in exchange for real monies corresponding to their bids.

At Step 224, the finished solution may be implemented. Those investors in the reservation market that held winning shares at time of closing enjoy the opportunity to become recipients of the property or participatory or other rights defined by the newly sanctioned market. In some instances, a sanctioning agreement may include additions or changes to the reservation market that have been negotiated with winning investors, the general public, legal entities, or others after closing of the market. Winning bids may now be paid as real monies. These monies may be used to fund the new venture or are distributed in some manner as defined by the reservation market.

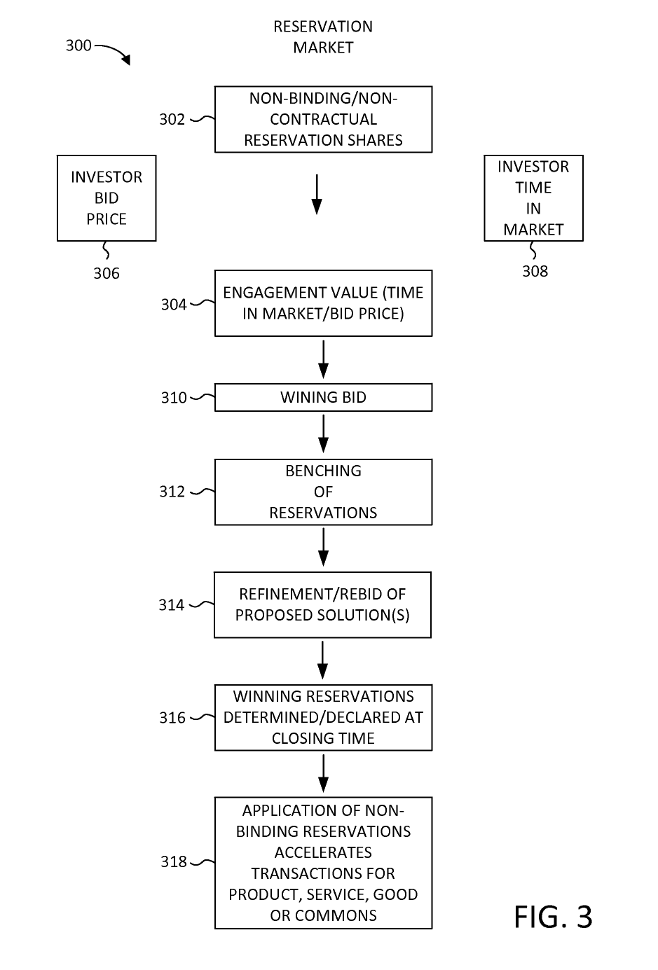

Referring next to FIG. 3 of the drawings, a block diagram which illustrates an illustrative reservation market 300 according to the methods for market reservation is illustrated. The reservation market 300 may include reservation shares 302 in at least one proposed solution to a complex issue related to public commons such as wetlands, forestlands and fisheries, for example and without limitation. Reservation shares 302 in the market may be offered to one or more reservation holders or investors. Those investors with the highest engagement values may obtain non-binding or non-contractual reservation shares 302. The engagement value 304 of each investor may be determined using the investor's bid price 306 and the investor's time in the market 308. The engagement value 304 may determine the winning bid 310 such that the investor having the highest engagement value may be awarded the winning bid 310. The formula for the engagement value 304 of each investor may be set at any point between the following end points: (time in market=0%/bid price=100%) and (time in market=100%/bid price=0%).

Benching of reservation shares 312 may take place as an existing investor's reservation shares in the reservation market are trumped and replaced by another investor bidding with a higher engagement value than the existing investor. Refinement of the market followed by continued trading of the market and/or rebidding of the proposed solution or solutions to which the reservation shares are directed 314 may take place as potential values, stakeholders, or investors and innovations for the proposed solution are revealed and/or the general public, media, market participants, and others suggest improvements to that market. Trading of reservations in the market may take place prior to legal authorization of the solution proposed by that market. Winning reservations may be determined or declared at a closing time 316 unknown to participants in advance of the closing time 316. Application of nonbinding reservations may accelerate transactions for those products, services, goods or commons 318 related to the reservation market as compared to transaction rate for those products, services, goods, or commons in the absence of a reservation market.

The following non-limiting examples illustrate various reservation markets according to the methods of the disclosure:

### Example 1

California Condors represent a degraded commons. California Condors have increased from a low of 22 birds in the wild in 1987 to approximately 225 in the wild today. This protected species is managed by the U.S. federal government. According to the methods of the disclosure, a subscriber 106, 108, 110 or market creator or any other entity may submit an issue to the reservation market provider 102. The issue may ask whether the federal government is managing this degraded commons to the best of its ability and whether a population growth of eight birds per year over the past 25 years is satisfactory. The reservation market provider 102, a subscriber 106, 108, 110, the general public 112, the implementing entity 114 or an investor or potential investor 116, 118, 120, or any other entity may propose a rudimentary solution to the issue. After measuring investor suitability and interest in the rudimentary solution and establishing reservation shares, the reservation market provider 102 may launch a portfolio of 10 proposed reservation markets for California Condors. Each reservation market may include different parameters for ownership, incentive, license, etc. The ultimate goal would be to improve the overall status of the species through creation of new recovery arrangements and stakeholders. The reservation market provider 102 may receive bids or offers for reservation shares from investors 116, 118, 120 and seek input and proposed refinements of the rudimentary solution from the subscriber or subscribers 106, 108, 110, the general public 112, investors 116, 118, 120, the sanctioning body 111, the implementing entity 114, and/or any other entity

After several months of refinements, imagine four of the 10 markets demonstrate the most economic activity as follows:
1) Baseline: Maintain management by the U.S. federal government;
2) Rancher: Implement a South African model (see Economics Appendix I), allowing ranchers, as the implementing entity 114, to own tagged Condors nesting on their property;
3) Crowd Source: Tag each Condor and allow the general public 112 as the implementing entity 114 to contribute to individual birds; and
4) Casino: Attach a gaming license to tagged birds and sell that license exclusively to those casinos with a Nevada gaming license. Thus, the licensed casinos are the implementing entity 114 and the federal government is the sanctioning body 111.

Imagine the fourth market, “Casino,” eclipses all others from an economic perspective with $50 million in reservations. Thus, Nevada casinos have bid a total of $50 million for a limited number of licenses in this first-of-its-kind, to be federally sanctioned, “eco-gaming” market. Specifically, this market may propose that the federal government provide vested casinos, as the implementing entity 114, and investors 116, 118, 120 with an exclusive right to buy, sell, and create gaming around individually tagged Condors. Breeding and protection would remain under federal authority. Casinos would be allowed to attach flight monitors to each bird and place web cams in nests. Casinos would enjoy the opportunity to create eco-gaming around flight duration and altitude, nest location, mating and offspring, lifespan, etc. Fledged chicks would represent a windfall gain for that casino “owning” the parents. Condors lost to poaching or other cause, by contrast, would represent a windfall loss to the casino. Funds from initial licensing and annual renewals would support continued federal breeding and habitat programs. Eighty percent of gaming profits would go to the casinos, 20% to the federal recovery program. Accordingly, the proposed market would create new stakeholders for California Condors. These stakeholders (casinos) would have legal, financial, marketing, and security resources that can be put to work in defense of the species.

This reservation market may be launched prior to any federal legislation authorizing such a market. The methods of the disclosure may keep track of participants' engagement in the market and total dollars bid on the project. As the market develops, the reservation market provider 102 may facilitate investors' ability to communicate ideas for market refinement. In addition, the reservation market provider 102 may oversee a public forum in which the public, the media, elected officials, government regulators and others can advance their cause and interests in the market. In this manner, the methods of the disclosure may create a contest between the status quo and a new, proposed alternative. Unlike past challenges to the status quo which may be advanced by a resilient few in the political arena, the challenges provided by the methods of the disclosure include price discovery, stakeholder discovery, innovation, ownership by degree and transaction acceleration (see Economics Appendix I) which help to drive change. Defenders of the status quo would now be required to justify their decades-old program against the bustling promise of this new reservation market.

Possible outcomes of the methods may be that the status quo prevails. If so, society is served by this contest because its citizenry is better educated regarding the merits of the status quo and the shortcomings of proposed alternatives. On the other hand, change may triumph. For example, government regulators may indicate a willingness to sanction the reservation market, but only if certain stipulations are met.

Rounds of negotiation may follow in which the reservation market provider 102 seeks a resolution that honors investors' participation in the reservation market while incorporating regulators' new demands One possibility is that federal regulators may seek investment assurance and assistance from the reservation market provider 102 in refining this new market. For example and without limitation, regulators may ask participating casinos to place money in escrow as proof of their willingness to invest. In addition, regulators may request of the reservation market provider 102 a second round of bidding, based upon a fine tuning of the market. For example, regulators may ask that the market include mandatory licenses for regional Native American tribes. The methods may be used to rebid the market accordingly. Additionally, regulators may ask that a third round of bidding take place in an effort to learn how the U.S. federal government can maximize revenue from licensing or fees. If so, the reservation market provider 102 could launch additional markets, each with different parameters for licenses or fees. Typically, investor response would form a bell curve allowing the U.S. federal government to learn which scenario maximizes investor participation and government revenue before the program is launched. In this manner, the reservation market provider 102, using the methods of the disclosure, may perform a discovery role that maximizes opportunities for success for all parties. The ultimate goal of the methods of the disclosure is an outcome in which investment activity, revenue and participants are largely understood prior to market results being officially sanctioned or launched.

### Example 2

Reservation markets created according to the methods of the disclosure as set forth in FIG. 2 may be used for refining venture capital ideas. As a reservation market creator, an entrepreneur may use a reservation market to sell shares in 10% of his proposed project to investors 116, 118, 120. The reservation market creator may use the reservation market to obtain input from the general public 112 or investors 116, 118, 120 or others to refine and/or re-bid his project on multiple occasions, ultimately allowing him to perfect the proposed or finished project before presenting the remaining 90% of shares to traditional venture capital funding groups which may fund the project as the implementing entity 114.

### Example 3

Reservation markets created according to the methods of the disclosure as set forth in FIG. 2 may be used by corporations which subscribe to the reservation market provider 102 for establishment of reservation markets used for the purpose of managing the launch and pricing of initial public offerings (IPOs). Investment banks could subscribe to the reservation market provider 102 to establish a reservation market for the purpose of selling shares in 1% of a proposed IPO to investors 116, 118, 120. This reservation market with its potential refinements and/or re-bids would provide an indication of the potential viability and value of an official IPO and would assist underwriters as the implementing entity 114 in managing the launch and accurate pricing of the IPO prior to the official public offering.

### Example 4

Reservation markets created according to the methods of the disclosure as set forth in FIG. 2 may be used to refine existing products, services and institutions. A Fortune 500 corporation may subscribe to the reservation market provider 102 for the establishment of a reservation market to explore the potential value in selling one or more subsidiaries of the corporation to one or more purchasers, which would act as the implementing entity 114. Different reservation markets could be used to test multiple scenarios and outcomes allowing the corporation to make an informed decision in advance of the sale of the subsidiary.

### Example 5

City councils may use reservation markets to create, bid, and publicly vet potential investment scenarios for major projects such as light rail construction, airport expansions, or the building of professional sports stadiums. Voters may use reservation markets as a way to explore reform or expansion or privatization of government services. Authoritarian governments may use reservation markets as a tool for testing scenarios and planning the liberalization of their economies.

### Additional Details

In some embodiments of the methods, reservation markets may be launched by authorized officials within an institution seeking reform of that institution (shareholder markets). Shareholder markets enjoy the advantage of being sponsored by those with authority to sanction the market. Alternatively, reservation markets may be launched by unauthorized individuals or those outside an institution (activist markets). Activist markets enjoy the opportunity to challenge the status-quo with new proposals powered by price discovery, stakeholder discovery, innovation, ownership, and transaction acceleration (see Economics Appendix I).

In various embodiments of the methods, reservation markets may be public or private. For example, the reservation market creator for a venture capital project may wish to keep its proposed product, process or services confidential by utilizing a private reservation market. Alternatively, those concerned with an environmental issue may seek vast participation through a public market.

Standard markets are defined by investors reserving shares and driving prices up. RFQ (request for quote) markets (see 00109) are defined by potential contractors bidding on proposed services and driving prices down.

In some embodiments of the methods, investors 116, 118, 120 may be allowed to sort reservation markets by the general theme of the market (government, corporate or environmental). The reservation market may include a blend of multiple themes. For example and without limitation, Example 1 above incorporates government regulation, corporate interests and environmental outcomes. The proposed outcome may be the focus in such a market. In this case, the theme of the Condor market in Example 1 above may be defined as environmental because the ultimate goal of the market is improving the Condor population in America.

The methods of the disclosure may differ from crowdsourcing in the following ways: A) Crowdsourcing may ask investors to make a financial commitment, often with credit card, towards a proposed project. Reservation markets according to the methods of the disclosure, by contrast, may ask investors to make non-binding reservations that the investors may choose to act upon (or not), at a future date. B) Crowdsourcing may utilize real currency for pledges. The methods of the disclosure, in contrast, may consummate transactions using funds from investors' assigned reserve values to make reservations. C) Crowdsourcing may offer a single solution to a problem or need. The methods of the disclosure, by contrast, may offer multiple solutions (and/or refinements thereof) to a problem or need. D) Crowdsourcing may offer investment opportunities presented by an authorized official(s). The methods of the disclosure may allow investors the opportunity to invest in authorized shareholder markets, but also the opportunity to invest in unauthorized activist markets. E) Finally, crowdsourcing may seek to fund projects through micro investments by “crowds” of investors. The methods of the disclosure may explore investment models that might be funded by crowds, a small group of individuals, or even a single investor such as institution or government entity.

The methods of the disclosure may differ from futures markets in the following ways: A) Futures markets may utilize real currency to purchase puts or calls or other financial products. Reservation markets according to the methods of the disclosure, by contrast, may consummate transactions using funds from investors' assigned reserve values to make reservations. B) Futures markets may require investors to make binding or contractual agreements when trading futures. According to the methods of the disclosure, investors may make non-binding reservations. C) Investors in futures markets may buy and sell their calls and puts at will. According to the methods of the disclosure, investors may only reserve shares. The sale (or benching) of reservations, when it occurs, may be beyond the control of investors in the reservation markets according to the methods of the disclosure. D) Trading in futures markets involves real gains and real losses. These transactions are taxable events. Reserving shares in the reservation markets according to the methods of the disclosure may not be a taxable event.

According to illustrative embodiments of the disclosure, investors 116, 118, 120 in a given reservation market may be assigned a reserve value, typically in accordance with their credit worthiness. The reserve value is the maximum amount an investor can invest in a given market. For example, a college student may be assigned a reserve value equal to his or her credit card credit. A private university may be assigned a reserve value equal to its endowment. A Fortune 500 company may be assigned a reserve value equal to its market capitalization. Reserve values may be assigned in any number of ways and may be equal to or a function of stated wealth. Assigning an appropriate reserve value may be important if the reservation market provider 102 is to achieve an accurately-priced and accurately-vetted reservation market. The methods of the disclosure may offer the reservation market provider 102 with the tools for applying a reserve value, with standardized parameters, to each investor.

When an investor reserves shares in a given reservation market, the value of those shares may be deducted from the investor's reserve value. Once the investor's reserve value is depleted, no further reservations may be allowed by that investor.

According to the methods of the disclosure, investors may secure reservations through the application of two variables: bid price and time accrued in the market. To successfully reserve shares, investors must have a winning bid. Winning bids are a combination of the investor's bid price and the investor's accrued time in the market. This combination of bid price and time may be referred to as “engagement value”.

Investors in a reservation market according to the methods of the disclosure are aligned vertically like rungs on a ladder, each with its own engagement value. When an investor invests in a market, the investor is not seeking to pay a market price, but is instead seeking to secure a rung on the ladder, and each rung comes at a different price. An investor with a high bid and high time to add to that bid will secure a rung high on the ladder—a position relatively safe from challengers. In contrast, an investor with a low bid and little time to apply to the bid secures a rung at or near the bottom of the ladder—a position vulnerable to challengers.

According to the methods of the disclosure, successful share reservations may accrue time from the time of purchase to the time of being benched or cancelled. This time may be accrued in 5-minute increments, or other time increment, and may be applied on a per-share basis. Because time changes, the engagement value of a reserved share may change incrementally with every incremental change in time. For example, if a reservation market includes the exact same reservation holders over a period of time (with no new investors and no new investment activity), it may be possible for these active reservation holders' engagement values to change relative to one another on the basis of time alone. In some instances, this could cause these investors to trade rungs on the ladder described above as a consequence of time passage alone.

Time is not an infinite variable in reservation markets according to the disclosure. For the individual investor, the value of time is not represented as an infinitely growing number but is instead represented as a percent of time relative to the total time of all reservations in the market. When compared against all reservation holders in a given reservation market, an individual investor might have 10% of time or 70% of time, but never more than 100% of time.

For the overall market, time is similarly represented and capped as a percent of engagement value. Thus, a typical market might be assigned an engagement formula in which investors' bid price is weighted at 95% and investors' time in market is weighted at 5%. In this case, time is capped at 5%.

According to the methods of the disclosure, reservation markets may be designed to more heavily weigh auction outcomes or more heavily weigh reservation outcomes simply by changing the time variable in the market engagement formula. For example, a market weighted at 90% bid price and 10% time is skewed towards an auction outcome. By contrast, a market weighted at 10% bid price and 90% time is skewed towards a reservation outcome. Changing this formula may lead to dramatically different outcomes for the same market in terms of funds raised, stakeholders revealed, and reservation holder or investor mix.

In some embodiments, the methods of the disclosure may utilize a unique method for investing called “benching”. Accordingly, rather than waiting for shares to be offered for sale, as is the case with traditional markets, investors in the reservation markets may acquire shares by offering a better engagement value than the existing reservation holders have bid. In this manner, the reservation markets may function like a unique blend of auction system and reservation system.

Traditional markets may allow investors to sell their shares. Reservation markets do not allow investors to sell their shares. According to the methods of the disclosure reservation markets may allow an existing shareholder to be benched by a challenger whose bid engagement value (bid price+time in market) exceeds the active investor's bid engagement value. When benching occurs, the reservation transfers from the existing reservation holder to the new reservation holder with higher bid engagement value. In benching, an investor's accrued time (time shares were held) for the benched reservation may be recorded on a per-share basis and stored in his or her time bank for later use.

In the event that a benched investor seeks to again purchase shares in the market, time from the time bank may be automatically applied to the new purchase on a 1 for 1, per share basis. When one new share is reserved, time from one share in the time bank may be applied to that new share reservation. Shares with the greatest time in the time bank may be the first to be applied to new purchases. For example, if an investor has 20 shares (each with an accrued time history) stored in his time bank, and that investor seeks to buy 10 new shares, the 10 shares in the time bank with greatest time accrued may be applied first to the new purchase. This time application boosts the investor's engagement value on the new purchase. The investor may not be provided control over this application of time, as it may be applied automatically, on every new bid. If an investor is new to the market and has not accrued any time, then the investor may be required to compete on the basis of bid price alone—with no time added to his or her bid.

Once a reservation transaction is confirmed, the time applied may be deducted from the investor's time bank. The new transaction shows an engagement value (bid price+applied time). New time may begin to accrue on the purchase and may be added to the existing or applied time. Accordingly, a share may be owned for only 5 minutes but may have an accrued time of 1,000 minutes if that share inherited time from a benched share in the time bank. In this manner, time is not a credit to be expended only once by market participants. Time is instead a measure of status for an investor, in a given market, that can be used over and over to win bids. The more accrued time an investor has on benched reservation shares, the easier time that investor will have securing new reservations. The value of this status may not be unlimited, but instead may be capped by the market engagement formula. For example and without limitation, if the formula is 95% bid price and 5% time, an investor's accrued investment time or status at most counts for 5% when bidding on new shares and seeking to retain existing shares.

According to the methods of the disclosure, investors may cancel shares at any time and forfeit all time accrued on those cancelled shares. Cancelled shares may revert to the market's cancelled shares account rather than to the investor's time bank. These shares may lose their accrued time and may not accrue additional time while in the cancelled shares account. At time of cancellation, these shares may be automatically priced (bid price alone, with no time added) such that their engagement value falls below the lowest active investor's engagement value. If cancelled shares are not reserved within a set time (such as 24 hours, for example), they may be set to erode in value at a given rate over a given period of time (for example, −2% per day). In this manner, cancelled shares may be made attractive to investors and eventually cleared from the cancelled shares account.

Cancelled shares may replenish an investor's reserve value at an amount equal to the most recent reservation price on those shares, and there may be no capital gain or loss.

According to the methods of the disclosure, markets may begin with all shares held in an opening shares account. All of the shares in the opening shares account may have a single market opening share price and may be available to be reserved by investors. Like cancelled shares, opening shares may not accrue time. Opening shares typically do not erode in value. If market conditions warrant a revision (i.e. market demand is unexpectedly low), however, opening shares may be set to erode in value at a given rate over a given period of time so as to clear the account (for example, −2% per day).

In some instances, unsold opening shares may be present when shares are cancelled. If so, the cancelled shares may be priced at the opening shares price, and the cancelled shares may clear first when the next investor seeks to purchase shares.

In some cases, a market may be paused and then re-introduced with refinements for additional bidding. In other instances, the market parameters may be changed while reservations are being actively traded. In either case, an investor's engagement value and/or time held in his or her time bank may continue unabated in the revised market. Suggested refinements may be managed by software or non-electronic means that allows participants to vote or rank refinements such that the market creator may decipher those refinements with potential appeal to participants and/or stakeholders.

According to the methods of the disclosure, reservation markets may include the following phases:

PENDING OPEN
OPEN
PAUSED
PENDING CLOSED
CLOSED

Pending open markets may be set to open at a pre-announced time and date. Open markets may be open to investors and may be actively traded. Paused markets may be paused for market refinements, legal questions, etc. Pending closed markets may be set to close during a pre-announced time period—(the month of June, for example). Closed markets are closed. Markets may be closed during the pending closed phase at an exact time and date (June 29, 2:30 PM EST, for example) which is unknown to investors in advance. In some embodiments, the closing date may be chosen at random, such as by a computer formula. Reservation markets may be designed to reveal value and stakeholders. By utilizing an unknown closing time and date, reservation markets incentivize investors to reveal their intentions, bids, trading activity, interests, suggested refinements, and more immediately rather than waiting until the last moment. In doing so, market outcomes may be digested by the general public, stakeholders, regulators, and others in a more open and expedient manner than would otherwise be the case.

According to illustrative embodiments of the disclosure, investors 116, 118, 120 may invest by reserving shares in a given market at a given price. These reservations may be non-binding. Investors 116, 118, 120 may not be required to consummate the transaction. Investors 116, 118, 120 may simply reserve the right to participate in a reservation market if it is sanctioned. A sanctioned market is one in which a governing or other body honors or legally sanctions the property or participatory or other rights proposed by that market. Using the California Condor in Example 1 above, a sanctioned market would be one in which the U.S. federal government passes legislation or regulatory law allowing Nevada casinos to own Condor licenses on the basis of a reservation market.

Once a market is sanctioned, investors may be given the opportunity to invest in the real venture based upon their winning reservations. Winning bids are then paid as real monies. These monies may be used to fund the new venture or are distributed in some manner as defined by the reservation market. Investors who fail to capitalize on their investment rights at time of sanctioning may lose rights to those shares. These unclaimed shares may be offered to remaining investors based upon each investor's existing percentage ownership in the sanctioned market. The investors to which the offer is made may choose to accept such shares or decline them without penalty.

When a market is first sanctioned, those investors which fail to capitalize on their reserved shares may be penalized with a lower credit rating. The credit reduction may be proportional to the amount invested (not counting time) divided by the investor's reserve value. For example, if an investor invests 10% of his or her reserve value in a reservation market and then fails to invest this amount in the sanctioned market, the investor's credit rating may be dropped by 10%, from 100 to 90.

Credit improvement may follow an identical procedure, except the credit gain may be divided by 2 (or any other factor) as a means of slowing credit ascent. For example, if an investor with a credit rating of 50 were to bid his or her entire reserve value on a market and then make good on that reservation in the sanctioned market, his or her credit rating may improve from 50 to 100, a gain of 50, but then the gain may be divided by 2 resulting in a new credit rating of only 75.

An investor's credit rating may have a proportional impact on the investor's reserve value. For example, an investor with a reserve value of $100,000 and a credit rating of 90 may only invest $90,000 in reservation markets. Credit ratings may encourage investors to be disciplined in their choice of investments—they should make reservations with an intention of making good on those reservations.

Each reservation market may be accompanied by a credit report which sums the credit worthiness of investors in that market. This feature may act as a tool allowing both participants and observers to assess the true potential of the market.

According to the methods of the disclosure, any investor may be assigned a lower credit rating for any reason which administrators of the method deem reasonable. For example, a hedge fund may register to participate in a reservation market, but upon review it may be discovered that the controlling investors in this hedge fund might have demonstrated low credit worthiness, in the past, in one or more reservation markets. If so, the credit rating of the hedge fund may be lowered to a rate which is subjectively chosen by the market provider.

In some embodiments of the methods, investors 116, 118, 120 may invest up to but not in excess of their assigned reserve value. Buying on margin may be disallowed. In some cases, an abruptly lowered credit rating may result in an investor being overbought. In these cases, reservation market providers 102 may rely on benching to naturally bring the investor 116, 118, 120 back in line with his or her reserve value. In other instances, the reservation market provider 102 may choose to take additional steps in order to bring the investor's reservations back in line with his or her reserve value.

In some illustrative embodiments of the methods, reservation markets may be defined as standard or RFQ (request for quote). Standard reservation markets may accumulate value by investors 116, 118, 120 reserving shares at ever-higher prices. RFQ reservation markets may achieve value by the opposite, reserving shares at ever-lower prices. RFQ markets may place a particular service or activity up for bid. Reservation market providers 102 may seek low bids rather than high bids. For example and without limitation, a metropolitan park district may provide its own labor for city park maintenance. A local citizen may feel such services could be better provided and at a lower price if put up for bid with outside contractors. This citizen could launch an RFQ market. Typically, such a market would be limited to a small number of shares, such as five or ten, that corresponds to the number of qualified bidders in this market.

RFQ markets may function like a conventional reservation market, in reverse. In some illustrative embodiments of the methods, RFQ reservation markets may use a formula that reverses that of standard reservation markets such that an ideal engagement value is one comprised of low bid and high time in market for the bidding investor.

While standard reservation markets may seek maximum funding from reservation holders, RFQ markets, by contrast, may seek the lowest bid from qualified reservation holders. Having the lowest bid and/or best engagement value may not assure an investor 116, 118, 120 of winning a future contract. Typically, any governing or other body that utilizes RFQ market results may make a subjective decision based upon low bid, high engagement and the trust (or lack thereof) they have in the bidder's ability to deliver the desired services. Reservation market providers 102 may clearly communicate to potential bidders both the objective and subjective nature of the RFQ market.

The illustrative embodiments of the methods according to the disclosure provide reservation market providers 102 with requirements for building and designing reservation markets. Some of the factors which may be taken into account in the creation of reservation markets may include the following without limit: time as a percent of engagement value, time accrual per share, number of shares issued to the opening share account, opening share price for shares, bid price increment (i.e. $1 increments), and maximum shares allowed per investor. Reservation market providers 102 may measure markets prior to launch against various internal parameters ranging from potential to expertise to organization. The methods of the disclosure may require that reservation market providers 102 abide by a host of parameters such as non-discrimination and decency in the design and management of their markets when creating a reservation market. Reservation market providers 102 may enjoy the right to close existing markets based upon lack of activity, negative media coverage or failure against any number of internal parameters.

Prospective investors may register as an investor 116, 118, 120 with the reservation market provider 102. Investors 116, 118, 120 may be required to complete a client profile including name, address, contact information and so on. In addition, clients may be expected to be vetted by the reservation market provider 102 on a variety of fronts, including net worth, as required by SEC regulation for participating in securities transactions.

In some instances, the reservation market provider 102 may require investors 116, 118, 120 in the market to complete a public profile. Public profiles may be used to inform the public about who is investing in a given market. The ultimate goal is accurate, public data that can be used to drive media coverage and public discourse related to the market. For example and without limitation, the Denver City Council may contract with a firm to launch a reservation market to explore the potential for building a new professional soccer stadium in the city. The reservation market provider 102 may require public profiles for any investor 116, 118, 120 reserving over $100,000 dollars in the project. The general public 112 may visit the reservation market online and view a report which lists the top investors 116, 118, 120 in the market.

In some embodiments, the reservation market provider 102 may require investors 116, 118, 120 to reveal their exact identities. Alternatively, the reservation market provider 102 may retain some anonymity for investors 116, 118, 120. For example and without limitation, an exact profile may read:
John Doe, Miami Fla. USA, reserver value $50,000

For example and without limitation, an anonymous profile may read:
Hedge fund, Bellevue Wash. USA, reserve value $200,000,000.
   or
Individual investor, Los Angeles Calif. USA, reserve value $100,000,000.
   or
Fortune 500 firm, Chicago Ill. USA, reserve value $2,000,000,000.

In some embodiments, the methods of the disclosure may provide the reservation market provider 102 with the tools needed to service the investors 116, 118, 120. For example, investors 116, 118, 120 may review investor reserve values, reserved shares, recently benched shares, market news and more. Investors 116, 118, 120 may sort reports by a variety of variables, obtain statements, etc. In addition, investors 116, 118, 120 may communicate directly with the reservation market provider 102 typically through the communication network 104.

In some embodiments, the general public 112 may visit reservation markets designated “public” and, without login or registration, review the investor profiles for these markets. This feature may be designed to create accountability and stimulate public debate on the merits of a given reservation market. Registered participants may be allowed to participate in a more active fashion within given reservation markets than the general public and may have the opportunity to comment on market blogs, submit issues, propose solutions to issues, suggest refinements, and/or comment on refinements.

Illustrative embodiments of the disclosure may provide tools that allow reservation market providers 102 to advance the cause of their markets. They may seek to poll their investors 116, 118, 120 on proposed refinements, respond to investor inquiries, lobby government officials and blog with the general public 112. All these objectives can be achieved through the methods of the disclosure.

TABLE I
CALIFORNIA FISHERY

| | |
|---|---|
| Time as % of Engagement Value | 5% |
| Ownership equals % of shares reserved | yes |
| OR Ownership equals engagement value | no |

| | | | | | | | | | Current Engagement Data | | | | |
|---|---|---|---|---|---|---|---|---|---|---|---|---|---|
| | | | | | | | | | $ Bid as | | Time as % | | |
| | | | | | | | | | % of | | of Total | | |
| Reser- | Reservation History | | | | | | | | Total | Time | Time on | | |
| vation | | | | | | Time | Reser- | Bid | Winning | Accrued on | Winning | Engagement | |
| Holder | Time 1 | Time 2 | Time 3 | Time 4 | Time 5 | 6 | vation | Amount | Bids | Reservation | Bids | Value | Ownership |
| A | 1 | 1 | 1 | 1 | 1 | | 1 | $52,000. | 20.23% | 5 | 26.32% | 20.54% | 20.00% |
| B | 1 | 1 | 1 | 1 | 1 | | 1 | $51,000. | 19.84% | 5 | 26.32% | 20.17% | 20.00% |
| C | 1 | 1 | 1 | 1 | 1 | | 1 | $50,000. | 19.46% | 5 | 26.32% | 19.80% | 20.00% |
| D | 1 | 1 | 1 | 1 | 0 | | 0 | $0.00 | 0.00% | 0 | 0.00% | 0.00% | 0.00% |
| E | 1 | 1 | 0 | 0 | 0 | | 0 | $0.00 | 0.00% | 0 | 0.00% | 0.00% | 0.00% |
| F | 0 | 0 | 1 | 1 | 1 | | 1 | $53,000. | 20.62% | 3 | 15.79% | 20.38% | 20.00% |
| G | 0 | 0 | 0 | 0 | 1 | | 1 | $51,000. | 19.84% | 1 | 5.26% | 19.12% | 20.00% |
| H | 0 | 0 | 0 | 0 | 0 | | 0 | $0.00 | 0.00% | 0 | 0.00% | 0.00% | 0.00% |
| I | 0 | 0 | 0 | 0 | 0 | | 0 | $0.00 | 0.00% | 0 | 0.00% | 0.00% | 0.00% |
| J | 0 | 0 | 0 | 0 | 0 | | 0 | $0.00 | 0.00% | 0 | 0.00% | 0.00% | 0.00% |
| | | | | | | | 5 | $257,000. | 100.00% | 19 | 100.00% | 100.00% | 100.00% |

Table I above shows a reservation market for a single, regional California fishery. Reservation holders are commercial fishermen bidding for 5 available licenses in the upcoming season. For example, reservation holder A has 1 share or reservation at a bid price of $52,000. The investor has held this reservation for 5 consecutive months without being benched or cancelling his or her reservation. This combination of bid price and time gives the reservation holder an engagement value of 20.54% in relation to the other 4 reservation holders. Reservation holder A holds a reservation that is relatively safe from challengers. Reservation holder G with a lower bid of $51,000 and only 1 month of accrued time and corresponding low engagement value of 19.12% is at risk of being benched by a challenger.

These reservation holders seek to maintain and defend their reservation up until the moment the market is closed. It is possible, in this example, that government regulators have agreed to participate in the reservation market and if funds raised from the test reservation market (in this case, $257,000) exceed that of their existing fishery license and revenue system, regulators may have authority to abandon their existing system and sanction this new market, with its winning reservation holders, as the new model for upcoming seasons.

Note that reservation holder B is rewarded for having participated in the market earlier than investor G, even though both share the same bid amount. Investor B enjoys an engagement value of 20.17% as compared to G with only 19.12%. The early participation of reservation holder B provides regulators, the public, the media, stakeholders, investors, and others with valuable, immediate results that may be digested, discussed and monitored over a period of months, and used to refine and improve the market prior to closing. Reservation holder B is doing the public a service by revealing his or her intentions early in comparison to investor G. Reservation holder G, by contrast, has withheld information from the public until the last month and in doing so diminishes his contribution to the knowledge and advancement of the fishery.

In some embodiments, ownership may be a function of an investor's reserved shares as percent of total shares in the market (as is the case in Table I above). In other embodiments, ownership may equal or correspond to the engagement value of each investor.

The following are non-limiting examples of public reports, investor reports, individual market variables, individual account variables, and types of market users in which the methods for market reservation may be implemented:

### Market Reports:

Public reports which are available to all visitors may include the following:
A market summary, market blog and market comment section.
A list of all reservation holders for a given market (including bid price, time accrued, and engagement value).
Average bid and average time for all reservation holders.
Recent cancellations (investor profile name, shares, date, and time forfeited).
Top refinement suggestions based on polling or voting data.

### Investor Reports:

Investor reports which are available to registered investors may include the following:
Active holdings (including bid price, time accrued, and engagement value).
Time bank holdings (benched shares and time on each share).
Calculator for discovering investment possibilities.

### Individual Market Variables:

Market variables may be set by a market administrator typically prior to, but in some instances during, market activity:
Time as a percent of the engagement formula for the overall market (i.e. 5%).
Time accrual interval for each share (i.e. 5 minutes).
Number of shares issued to opening share account.
Opening share price for these shares.
Bid price increment (i.e. market appreciates in $1 increments [no cents]).
Maximum shares allowed per investor.
Ownership determination (ownership equal shares as percent of total shares in market or ownership equals engagement value).

### Individual Account Variables:

Account variables may be set by a market administrator prior to and during market activity:
Reserve value per account.
Credit limit per account.
Time bank accrual rate (in minutes).
   For example, 5 minutes for an investor.
   Typically 0 for opening share account.
   Typically 0 for cancelled share account.
Share value erosion rate (erosion percent per share and erosion time interval)
   Typically not applicable for an investor.
   Typically 0 for opening share account.
   For example, −2% per day for the cancelled share account.

### Types of Market Users:

Public Visitor:
can view the following for a market: summary description, market blog, public comments.

Registered Subscriber:
enjoys the same features as Public Visitors.
has provided: name, city, state, country, email address.
may request notification of blog updates.
may post to blog comment section.
may submit an issue to be resolved.
may propose a solution to an issue.
may suggest market refinements and comment on suggested refinements.

Registered Investor:
enjoys the same features as Public Visitors and Registered Subscribers.
has opened an account by completing application with basic information.
has agreed to be billed monthly subscription fee.
has provided a credit card.
has submitted financial records and has been assigned a reserve value based upon them.
has had his or her account activated, as investor, by market provider staff.
may reserve shares in reservation markets.

Registered Market Creator
enjoys the same features as Public Visitors, Registered Subscribers, and Registered Investors.
has had his/her account activated, as market creator, by market provider staff.
may create and manage reservation markets.

Administrator
Staff member authorized to manage a reservation markets.
Staff member authorized to oversee management of reservation markets by registered market creators.

### ECONOMICS APPENDIX I

### Free Markets

A free market is a market in which the prices of goods and services are determined by supply and demand, free of government control. Free markets are perhaps best known for motivating individuals to act via the prospect of profit or loss. Free markets have lesser known attributes, however, that are of equal or greater importance in advancing society. For example, free markets play a critical role as price discovery mechanisms. Free markets around the world provide a single price for millions upon millions of complex products and services. This price information represents the compilation of billions of people making purchase and investment choices, every day. Only free markets can provide accurate price data, in such exquisite detail, for so many products and services, instantly.

Various institutions may act upon the price information which is provided by free markets in a manner that benefits society. For example, the cost of coronary stent surgery may average $40,000 in the United States of America. Various universities throughout the world may use this information when allocating funds for their medical research to improve upon that surgery. Architects may seek to reduce this cost when engineering new hospitals and operating rooms. Legislators may draw upon this information when crafting legislation such as no smoking laws. The media may use this information to inform the public regarding lifestyle choices. Technology companies may use this information when seeking to develop competitive alternatives. Thus, understanding the price of a particular surgery may be important for society when resources are allocated to improve upon that surgery. The same can be said for any product or service. Society benefits from extensive and accurate price data and free markets provide this data. According to the methods of the disclosure, price discovery can be applied to commons in decline as a means of rescuing or repairing those commons.

Free markets may also play a critical role in stakeholder discovery. Markets may provide a mechanism by which various stakeholders (everyone from inventors to designers to manufacturers to distributors to retailers to clients) find each other. Society benefits from the natural collaboration that takes place as a result. New ideas and processes have an opportunity to be heard and flourish in an arena of participants bound by similar interest, expertise, industry, etc. Society benefits when stakeholders collaborate. Thus, free markets are a segue to such collaboration. According to the methods of the disclosure, stakeholder discovery can be applied to commons in decline as a means of rescuing or repairing those commons.

Free markets provide a path to innovation. Free markets may provide a democratic mechanism by which participants may present and measure the validity of new ideas. If a concept is promising, it will attract proponents in the form of investors, manufacturers, consumers and so on. If the concept fails to attract proponents, the concept will fail. This natural churn of concepts, allowed to originate from all corners of our social fabric, is beneficial in creating a vibrant and progressive society. Thus, free markets are a segue to such innovation. According to the methods of the disclosure, innovation can be applied to commons in decline as a means of rescuing or repairing those commons.

Conventionally, ownership is often perceived in absolute terms. In implementation of the methods of the disclosure, ownership may be considered a matter of degree. For instance, a Hollywood blockbuster movie may provide various degrees of ownership. One entity may own rights to a movie title. Another entity may own rights to the script or sequel. Still others may own cinema rights in South America or online distribution in Europe. Producers, directors, and actors may own rights to profits once revenue targets are reached. In short, the movie is owned by many and to varying degree.

By applying various degrees of ownership to a commons, outcomes can be radically altered. For example, South Africa is home to 90% of the world's population of endangered large mammals. A controversial 1970s law gave ranchers in that country ownership of wildlife on their property. These laws gave ranchers regulated authority to photograph, hunt, breed, buy, and sell wildlife, but in a limited sense. They could only do so in a regulated manner, and on their own land.

Since enactment of this law, wildlife numbers for endangered mammals have tripled in South Africa. Today there are over 10,000 private game farms and game refuges in South Africa, covering over 50 million acres of land. This private ecosystem encompasses land mass three times greater than that of government conservation areas in South Africa.

As set forth above (003-008), degradation is associated with concentrated gain and dispersed costs. The South African law changed this dynamic to one of concentrated gain and concentrated loss. Instead of society losing when a rhinoceros was poached, an individual (the South African rancher) lost as well. Rhinoceros are of value for breeding purposes, camera safaris, legal hunts, and may even serve as investment vehicles. (Note: a January 2014 auction for a black rhinoceros hunting license in Namibia brought $350,000). As a consequence, ranchers are incentivized to protect such wildlife on their land by hiring security firms, installing monitoring equipment, networking with neighbors and aggressively patrolling for and prosecuting poachers. The loss of a single black rhinoceros therefore fails to trigger a societal response because the loss is infinitesimal when distributed, on a per capita basis, among the world's citizenry. By contrast, the loss of a single black rhinoceros for the South African rancher is exceptional.

According to the methods of the disclosure, ownership to varying degrees can be applied to commons in decline as a means of rescuing or repairing those commons. This ownership may be crafted in such a manner as to maintain the natural state and public accessibility of commons.

In sum, free markets are saddled with a public perception that relates primarily to profit and loss, but the unheralded virtue of these markets lies in price discovery, stakeholder discovery, innovation, and ownership by degree. The methods of the disclosure may capitalize on these overlooked attributes to repair degraded commons.

### ECONOMICS APPENDIX II

### Transaction Count

Free markets advance society via the above described price discovery, stakeholder discovery, innovation, and ownership. These processes hinge on transactions between buyers and sellers, signaling value. More transactions therefore equate to more price discovery, more stakeholder discovery, more innovation, and potentially more ownership arrangements.

The role of economic factors such as revenue and profit are well-known in relation to resource allocation, in contrast to the role of transaction count. For example, two competing electronic manufacturers may enjoy identical revenue and profits but different transaction count. The first may sell 1 million smart phones at a high price, whereas the other may sell 10 million smart phones at a low price. It is largely unknown, but possible that the company with 10 million transactions enjoys a competitive advantage in the form of increased potential for price, stakeholder and innovative discovery.

Transaction count may provide a tool that can be used to predict outcomes. For example, consider the following scenario. During the 2008 American presidential election, the Democrat and Republican political parties raised roughly similar amounts of money, although the Democrats enjoyed a higher transaction count. Millions of citizens gave $20 each to the Democrats, whereas thousands of citizens gave $2,000 to the Republicans. In this situation, equal fundraising but lopsided transaction count may have portended what was ultimately a landslide victory for Democrats.

Transaction count may be a constant in society or its influence may evolve as a society progresses from an agrarian to industrial to information-based economy. For example, in the past, economic wealth was a function of assets such as tillable land or oil deposits. During this era, transactions recorded the transfer of such assets from one entity to another. Today, the transaction itself (for example internet clicks, visits, or likes) generates wealth. This may indicate that the future is a race for transaction count and corresponding knowledge rather than assets. More transactions may equate to more price discovery, more stakeholder discovery and more innovation.

A signature characteristic of degraded commons is a low transaction count. For example, millions of shares per hour are traded daily in the economically-vibrant silicon chip market. By contrast, there are little to no transactions annually for endangered bow whales, Hawaiian monk seals or the Red Knot. According to the methods of the disclosure, transaction acceleration can be applied to commons in decline as a means of rescuing or repairing those commons.

### ECONOMICS APPENDIX III

### Discovery

The primary role of reservation markets is not capital appreciation for investors, but discovery. In some instances with conventional funding tools such as stock markets, existing rules or investment strategies may impede discovery. For instance, when investors employ a buy-and-hold strategy for long-term investment purposes, this strategy may reduce transaction count for a market and result in corresponding loss of price discovery. Similarly, when significant capital gains underlie a market price, this can impede stakeholder discovery if the market were traditional in structure. For example, a nascent reservation market may be spotted by a group of bright high-school students who invest heavily in low-price shares and then ride the market to the top. When it comes time to sanction this market, these students presumably have little real money to invest in the sanctioned venture. To this extent, their paper gains distort the true price or value of this market.

To resolve such issues, the methods of the disclosure may utilize a unique method for investing called “benching”. Accordingly, rather than waiting for shares to be offered for sale, as is the case with traditional markets, investors in the reservation markets according to the methods of the disclosure may acquire shares by offering more money for shares and/or better engagement value than the existing shareholders have pledged. In this manner, the reservation markets may function like a unique blend of auction and reservation system.

As an example, let's say that a first investor purchases shares in a reservation market with an engagement bid of $10 per share and 5 days' time. A second investor may bench the first investor by offering an engagement bid of $11 per share and 6 days' time. To use a sports analogy, the second investor pushes the first investor aside, takes his shares and now occupies his position on the field of play (the first investor has been benched).

According to the methods of the disclosure, investors with the lowest reservation price and/or engagement value per share may be benched first. When two or more investors have purchased shares at an identical price and/or engagement value, the investor that purchased shares most recently may be the first to be benched when prices rise. Investors may have all or a portion of their shares benched at any time.

Benched shares may replenish an investor's reserve value at an amount which is equal to the most recent reservation. There may be no capital gain or loss. Benching may achieve the following:

1) Price discovery: Benching may eliminate the unrealized capital gains that underlie traditional markets. Thus, the market value for a given reservation market may be supported by a plethora of recent share purchases made at or near the existing market value rather than by unrealized paper profits. To the extent this is true, the market value may be stable and valid.

2) Stakeholder discovery: Just as benching reveals a realistic price for a reservation market, so too does benching reveal true stakeholders. Using the example of the high school students above, as a market appreciates, the high-school students get benched and must re-enter the market, but at an ever-higher share price. In doing so, the students likely struggle to meet the reserve requirement for ever more expensive purchases. As they are squeezed out, the students are replaced by institutions, corporations, hedge funds and others that can meet the reserve requirement demanded by the higher share price. These institutional stakeholders may bring credibility to the reservation market.

3) Transaction acceleration: Benching may eliminate buy-and-hold as an investment strategy for reservation markets, and thus, put more shares in play at any given time. The outcome may include more price, stakeholder and innovative discovery.

In some embodiments of the methods of the disclosure, investors may be notified when their shares have been benched and may use tools for automatically re-investing in a given market.

Investors in traditional markets pay market price for their shares and later may choose when and at what price to sell. In the reservation markets according to the methods of the disclosure, in contrast, investors may have control over their reservation price but no control over when or at what price their shares are benched. A potential downside of benching, if left unattended, may be that some investors wait until the last moment to place their bids and in doing so achieve a surprise victory over long-standing reservation holders, just before the closing of the market. This may defeat the primary goals of price and stakeholder discovery.

To remedy this issue, the methods of the disclosure may calculate an investor's right to participate in the sanctioned market upon two variables: bid price and time in the market. The sum of these two variables may be designated the “engagement value”. As an example, two investors would like to reserve an available share in a reservation market. Investor A is new to the market and has accrued no time. Investor B has been investing in the market for a year or more and in doing so has accrued time in his or her time bank. Both investors bid $20 each for the share. In this case, investor B will win the reservation because this investor can add accrued time to his or her $20 bid, giving investor B a higher engagement value than investor A. The use of engagement value incentivizes investors to invest earlier than might otherwise be the case and in doing so promotes price, stakeholder and innovative discovery.

The engagement value formula (amount invested+time accrued) may vary from one reservation market to another. For example, the formula for one reservation market may be 95% invested and 5% time, and the formula for another reservation market may be 75% invested and 25% time.

Reservation markets can be designed to more heavily weigh auction outcomes or more heavily weigh reservation outcomes by simply changing the time variable in the engagement value calculations. For example, a market weighted at 90% bid price and 10% time is skewed towards an auction outcome. By contrast, a market weighted at 10% bid price and 90% time is skewed towards a reservation outcome. Changing this formula can lead to dramatically different outcomes for the same reservation market in terms of funds raised and reservation holder mix.

In addition to engagement value, an unknown market closing date and time incentivizes investors to invest early (well before the market closes) and in doing so promotes price and shareholder discovery earlier than might otherwise be the case.

### ECONOMICS APPENDIX IV

### Degraded Commons & Nobel Prize

In 2009, Elinor Ostrom won the Nobel Prize in Economics for her study of common pool resources (or commons). Ostrom's case studies focus on commons throughout the world such as fisheries, irrigation systems and timber lands. Ostrom demonstrated that commons have been successfully managed, in some cases for centuries, by the appropriators (existing users, such as herdsmen) of those commons. This management has been achieved without privatization of the resource and without the outside intervention of government authorities. Ostrom has argued that privatization is difficult, if not impossible, to employ in managing many common pool resources. While it is known that land can be easily fenced and privatized, less is known about privatization of fisheries, herds of wild elk or watersheds. Intervention by the state, on the other hand, often complicates delicate negotiations between appropriators, places management in the hands of those without intimate knowledge of the commons, and opens the door to corruption. Destructive practices may follow.

Ostrom has further argued that sustainability of commons requires a willingness to manage for the long-term combined with an intimate knowledge of the resource itself. Appropriators themselves may provide these two critical components. Ostrom's work reveals that, given the right parameters and protection from outside influences, appropriators are able to manage, monitor and arbitrate successful outcomes for a commons over a period of centuries, in some cases. Ostrom's work underscores the potential success of people who are connected to their reserve and working towards a common goal.

Ostrom's thesis is that existing appropriators are best suited to manage a commons. In Hardin's example (and one referenced by Ostrom), the appropriators would be the cattle herdsmen. Ostrom seeks to maximize outcomes for these appropriators and sees them as the key to unlocking tragedy of the commons. Ostrom fails, however, to ask and makes no accommodation for how different appropriators such as goat herders or sheep herders might be incorporated in the management of a commons such as a meadow. By choosing existing appropriators as her linchpin, Ostrom ropes herself into a corner where alternative appropriators are unable to play a role. The methods of the disclosure, by contrast, allow for numerous appropriators to enter a market and bid for a position in the solution. By refining successive markets and/or competing markets, solutions that reveal potential outcomes for a diversity of appropriators—both existing and—new—may be formulated. Cattle herders, goat herders and sheep herders—in fact, anyone—may participate in a reservation market which is related to the grazing meadow.

In similar fashion, Ostrom presumes that existing usage of a given commons is ideal. It may, however, be asked whether such is the case or if society would be better served if the meadow were converted to a wildlife preserve, a soccer facility or an elementary school; it may be that grazing cattle is not the optimal use of the commons. Thus, Ostrom fails to account for how different uses of the commons might be determined and weighed. The methods of the disclosure, by contrast, allow for a multitude of proposed uses to be introduced, vetted and refined with reservation markets. While they may be tilted towards measuring financial outcomes, reservation markets may also represent a platform for introducing and discussing intangibles such as beauty, quality of life or sustainability. The reservation markets may reveal potential outcomes; it remains for society to choose which one is best.

Possession dominance is a real and substantial barrier to change as it relates to common pool resources. Existing appropriators enjoy price and stakeholder knowledge combined with existing revenue from the resource. This substantial advantage is always in play as a weapon to quash those seeking reform or alternate uses of the commons. Ostrom, however, fails to address this influential and often destructive force.

By contrast, the methods of the disclosure address possession dominance directly. The methods may provide challengers of the status quo with the requisite price and stakeholder information necessary for advancing alternate users and/or uses of the commons. While existing stakeholders may continue to enjoy a financial advantage via their mining of the common resource, the methods of the disclosure may provide an opportunity for this advantage to be eclipsed by revealing potential new innovations and new appropriators, in part or in their entirety, via reservation markets.

Each commons which Ostrom analyzes exists as an independent and unique solution in which success has been winnowed from a hailstorm of economic, political, cultural and ethnic variables. By Ostrom's admission, reproducing the success of Swiss cattlemen or Japanese irrigators on the streets of Brooklyn is cumbersome in theory and perhaps even more so in practice.

By contrast, the methods of the disclosure may embrace diversity and welcome the multitude of variables presented by different commons throughout the world. Reservation markets that begin with the greatest number of variables, questions and proposals may enjoy the greatest likelihood of achieving an inspiring outcome. More variables may be better, and no two outcomes need to be the same for reservation markets to succeed. Each commons may represent a unique puzzle with a unique answer. Reservation markets, by design, accommodate and thrive on this complexity.

In conclusion, over 2,000 papers and books, including those by Ostrom, have been written in an attempt to solve tragedy of the commons or prisoner's dilemma. In the vast majority of cases, these authors seek a single key to the puzzle. Ostrom breaks new ground by proposing that each commons may require a unique solution and that current appropriators of that commons are likely best suited to discover that solution. The methods of the disclosure take Ostrom a step further by proposing a mechanism by which countless codes might be tested in an attempt to determine which appropriators, which uses and which ideas for the commons might best unlock value.

While illustrative embodiments of the disclosure have been described above, it will be recognized and understood that various modifications can be made in the disclosure and the appended claims are intended to cover all such modifications which may fall within the spirit and scope of the disclosure.

What is claimed is:

1. A method for market reservation, comprising:
submitting an issue to be resolved;
proposing at least one rudimentary solution to the issue to be resolved;
measuring suitability and interest of potential investors in the at least one rudimentary solution to the issue to be resolved;
establishing a reservation market having reservation shares for each of the at least one rudimentary solution;
receiving a bid or offer from at least one investor from among the potential investors for at least one reservation share in the reservation market;
formulating a finished solution; and
providing the at least one investor with an option of retaining the at least one reservation share in the reservation market at a price corresponding to the bid or offer.

2. The method for market reservation of claim 1 wherein establishing a reservation market having reservation shares for each of the at least one rudimentary solution comprises establishing a reservation market having reservation shares which are non-binding to the at least one investor.

3. The method for market reservation of claim 1 further comprising receiving input and proposed refinements of the at least one rudimentary solution, and wherein revising and refining the at least one rudimentary solution comprises revising and refining the at least one rudimentary solution based on the input and proposed refinements.

4. The method for market reservation of claim 1 wherein receiving a bid or offer from at least one investor from among the potential investors for at least one reservation share in the reservation market comprises receiving a first bid or offer from a first investor having a first engagement value and a second bid or offer from a second investor having a second engagement value higher than the first engagement value, and the at least one reservation share of the first investor is displaced or benched by the at least one reservation share of the second investor.

5. The method for market reservation of claim 1 further comprising revising and refining the at least one rudimentary solution prior to formulating the finished solution.

6. The method for market reservation of claim 1 wherein providing the at least one investor with an option of retaining the at least one reservation share in the reservation market at a price corresponding to the bid or offer comprises providing the at least one investor with an option of retaining the at least one reservation share in the reservation market at a price corresponding to a highest bid.

7. The method for market reservation of claim 1 wherein providing the at least one investor with an option of retaining the at least one reservation share in the reservation market at a price corresponding to the bid or offer comprises providing the at least one investor with an option of retaining the at least one reservation share in the reservation market at price corresponding to a bid with the most accrued time in market.

8. The method for market reservation of claim 1 further comprising determining an engagement value of the at least one investor using the investor's bid price and the investor's time in the market.

9. The method for market reservation of claim 1 wherein providing the at least one investor with an option of retaining the at least one reservation share in the reservation market at a price corresponding to the bid or offer comprises determining and declaring winning reservation shares at a closing time unknown to participants in the reservation market.

10. The method for market reservation of claim 1 further comprising sanctioning the finished solution.

11. The method for market reservation of claim 1 further comprising implementing the finished solution.

12. The method for market reservation of claim 1 further comprising the awarding of the at least one investor property or participatory or other rights based on the number and pricing of reservation shares in the sanctioned reservation market.

13. The method for market reservation of claim 1 wherein the market is comprised of reservations.

14. The method for market reservation of claim 1 wherein the market comprises reservations, thereby allowing market outcomes to be revealed prior to legal authorization of the proposed solution.

15. The method of market reservation of claim 1 wherein the market introduces and vets new ideas to overcome possession dominance.

16. The method for the market reservation of claim 1 wherein the market is used as a tool for designing solutions.

17. A method for market reservation, comprising:
receiving an issue to be resolved from at least one subscriber;
proposing at least one rudimentary solution to the issue to be resolved;
measuring suitability and interest of potential investors in the at least one rudimentary solution to the issue to be resolved;
establishing a reservation market having reservation shares;
receiving a bid or offer from at least one investor from among the potential investors for at least one reservation share in the reservation market;
receiving input and proposed refinements of the at least one rudimentary solution from at least one of the at least one subscriber, the general public, an implementing entity and/or at least one of the at least one investor;
formulating a finished solution based on the input and proposed refinements of the at least one rudimentary solution by revising and refining the at least one rudimentary solution;
sanctioning the finished solution;
providing the at least one investor with an option of retaining the at least one reservation share in the reservation market at a price corresponding to the bid or offer; and
implementing the finished solution.

18. The method for market reservation of claim 17 wherein providing the at least one investor with an option of retaining the at least one reservation share in the reservation market at a price corresponding to the bid or offer comprises providing the at least one investor with an option of retaining the at least one reservation share in the reservation market at a price corresponding to a highest bid.

19. The method for market reservation of claim 17 wherein providing the at least one investor with an option of retaining the at least one reservation share in the reservation market at a price corresponding to the bid or offer comprises providing the at least one investor with an option of retaining the at least one reservation share in the reservation market at a price corresponding to a bid with the most accrued time in market.

20. The method for market reservation of claim 17 further comprising determining an engagement value of the at least one investor using the investor's bid price and the investor's time in the market.

21. The method for market reservation of claim 17 further comprising awarding of the at least one investor property or participatory or other rights based on number and pricing of reservation shares in the reservation market.

22. The method for market reservation of claim 17 wherein receiving an issue to be resolved from at least one subscriber comprises receiving an issue relating to protection of endangered species from at least one subscriber.

23. The method for market reservation of claim 17 wherein receiving an issue to be resolved from at least one subscriber comprises receiving an issue relating to refining venture capital ideas from at least one subscriber.

24. The method for market reservation of claim 17 wherein receiving an issue to be resolved from at least one subscriber comprises receiving an issue relating to pricing of initial public offerings from at least one subscriber.

25. The method for market reservation of claim 17 wherein receiving an issue to be resolved from at least one subscriber comprises receiving an issue relating to the refining of existing products, services and institutions from at least one subscriber.

26. The method for market reservation of claim 17 wherein receiving an issue to be resolved from at least one subscriber comprises receiving an issue relating to protection of endangered species from at least one subscriber.

27. A method for market reservation, comprising:
receiving an issue to be resolved from at least one subscriber;
proposing at least one rudimentary solution to the issue to be resolved;
measuring suitability and interest of potential investors in the at least one rudimentary solution to the issue to be resolved;
establishing a reservation market having reservation shares;
receiving bids from a plurality of investors from among the potential investors for at least one reservation share in the reservation market;
receiving input and proposed refinements of the at least one rudimentary solution from at least one of the at least one subscriber, the general public, an implementing entity and/or at least one of the at least one investor;
formulating a finished solution based on the input and proposed refinements of the at least one rudimentary solution by revising and refining the at least one rudimentary solution;
sanctioning the finished solution;
providing at least one of the plurality of investors with an option of retaining the at least one reservation share in the reservation market at a price corresponding to a highest bid;
implementing the finished solution; and
awarding the at least one investor property or participatory or other rights based on number and pricing of reservation shares in the reservation market.

28. The method for market reservation of claim 27 wherein receiving an issue to be resolved from at least one subscriber comprises receiving an issue relating to refining venture capital ideas from at least one subscriber.

29. The method for market reservation of claim 27 wherein receiving an issue to be resolved from at least one subscriber comprises receiving an issue relating to pricing of initial public offerings from at least one subscriber.

30. The method for market reservation of claim 27 wherein receiving an issue to be resolved from at least one subscriber comprises receiving an issue relating to the refining of existing products, services and institutions from at least one subscriber.
